(19) United States
(12) Patent Application Publication
(10) Pub. No.: US 2018/0365527 A1
(43) Pub. Date: Dec. 20, 2018

(54) METHOD AND DEVICE FOR CONTROLLING EXPRESSION CLASSIFICATION IDENTIFIER, AND A STORAGE MEDIUM

(71) Applicant: Tencent Technology (Shenzhen) Company Limited, Shenzhen (CN)

(72) Inventors: Shaofeng Li, Shenzhen (CN); Minghao Chu, Shenzhen (CN); Xiaoming Yang, Shenzhen (CN); Huandin Lin, Shenzhen (CN); Renshou Zhang, Shenzhen (CN); Zhijie Liang, Shenzhen (CN)

(21) Appl. No.: 16/112,473

(22) Filed: Aug. 24, 2018

Related U.S. Application Data
(63) Continuation of application No. PCT/CN2017/074795, filed on Feb. 24, 2017.

(30) Foreign Application Priority Data
Apr. 15, 2016 (CN) 201610235335.0

(51) Int. Cl. G06K 9/62; G06F 3/0481; H04L 12/58; G06F 3/023

(52) U.S. Cl. CPC G06K 9/6267; G06F 3/0236; H04L 51/046; G06F 3/04817

(57) ABSTRACT

The present disclosure discloses a method for controlling a sticker classification identifier performed at a computing device. The computing device displays an instant messaging user interface including a user input region and a sticker messaging option. After detecting a user selection of the sticker messaging option, the computing device updates the instant messaging user interface by displaying a sticker panel below the user input region, the sticker panel including one or more sticker classification identifiers, each sticker classification identifier further including one or more stickers. After obtaining a movement instruction applied to a first sticker classification identifier of the one or more sticker classification identifiers, the computing device performs a first operation on the first sticker classification identifier by moving the first sticker classification identifier from a current position to a target position without moving the one or more stickers of the first sticker classification identifier.

### RELATED APPLICATION

This application is a continuation-in-part application of PCT/CN2017/074795, entitled “METHOD AND APPARATUS FOR CONTROLLING STICKER CLASSIFICATION IDENTIFIER, AND STORAGE MEDIUM” filed on Feb. 24, 2017, which claims priority to Chinese Patent Application No. 201610235335.0, entitled “METHOD AND APPARATUS FOR CONTROLLING STICKER CLASSIFICATION IDENTIFIER, AND STORAGE MEDIUM” filed with the Patent Office of China on Apr. 15, 2016, all of which are incorporated herein by reference in their entirety.

### FIELD OF THE TECHNOLOGY

The present disclosure relates to the field of multimedia, and more particularly, to a method and an apparatus for controlling a sticker classification identifier, and a storage medium.

### BACKGROUND OF THE DISCLOSURE

In the modern society, with the rapid development of instant messaging services, people communicate with each other by increasingly using the instant messaging services. Moreover, people also enjoy convenience in communication and brought by the instant messaging services. For example, people may send stickers to each other to express the current mood, status, or the like. Compared with directly sent messages such as text, stickers can directly express the current mood of a user more vividly, and with the expansion of instant messaging services, sticker messages that can be sent by people are increasingly diverse. However, variations of sticker messages trouble people during selection of a sticker to be sent. Specifically, as shown in FIG. 2, an identifier 1 and an identifier 2 are sticker identifiers. Each sticker identifier includes a plurality of stickers. For example, a sticker corresponding to the identifier 1 is a sticker “the nervous frog and the merry horse”, and a sticker corresponding to the identifier 2 is a sticker “the wild and cute panda”. When the user wants to send the sticker in the sticker identifier 2, the user needs to slide an area 1 leftwards or rightwards, until the sticker in the identifier 2 is displayed in a terminal device. However, the foregoing method for selecting a sticker wastes a large amount of time of the user. Consequently, the user cannot send a sticker most quickly. Moreover, as shown in FIG. 2, if the user usually uses the sticker in the identifier 2 and seldom uses the sticker in an identifier 7, placing the identifier 7 in front of the identifier 2 also wastes time for selecting a sticker by the user. Therefore, the method for selecting a sticker in an instant messaging service in the related technology is disadvantageous for improving user experience.

At present, there is still no effective solution to the foregoing problem.

### SUMMARY

Embodiments of the present disclosure provide a method and an apparatus for controlling a sticker classification identifier, and a storage medium, to resolve at least the technical problem in the existing technology that the flexibility of controlling a sticker classification identifier is relatively poor.

According to one aspect of the embodiments of the present disclosure, a method for controlling a sticker classification identifier is performed at a computing device having one or more processors and memory storing a plurality of programs to be executed by the one or more processors. The computing device displays an instant messaging user interface, the instant messaging user interface including a user input region and a plurality of messaging options. These messaging options include an audio messaging option, a video messaging option, and a sticker messaging option. After detecting a user selection of the sticker messaging option, the computing device updates the instant messaging user interface by displaying a sticker panel below the user input region. The sticker panel includes one or more sticker classification identifiers, each sticker classification identifier further including one or more stickers. The computing device obtains a movement instruction applied to a first sticker classification identifier of the one or more sticker classification identifiers. The movement instruction is used to move the first sticker classification identifier on the sticker panel from a current position to a target position. After obtaining a first operation indicated by a first area in which the target position is located, the computing device moves the first sticker classification identifier from the current position to the target position without moving the one or more stickers of the first sticker classification identifier.

According to another aspect of the embodiments of the present disclosure, a computing device includes one or more processors, memory coupled to the one or more processors, and a plurality of programs stored in the memory that, when executed by the one or more processors, cause the computing device to perform the aforementioned method for controlling a sticker classification identifier.

According to still another aspect of the embodiments of the present disclosure, a non-transitory computer readable storage medium is provided for storing a plurality of programs that, when executed by one or more processors of a computing device, cause the computing device to perform the aforementioned method for controlling a sticker classification identifier.

In the embodiments of the present disclosure, an movement instruction is obtained, the movement instruction being used to move a first sticker classification identifier on a sticker panel to a target position, the sticker panel displaying one or more sticker classification identifiers including the first sticker classification identifier, and the first sticker classification identifier including one or more stickers, a first operation indicated by a first area in which the target position is located is obtained, and the first operation is performed on the first sticker classification identifier. A corresponding operation is performed on the first sticker classification identifier that is moved to the target position and in the sticker panel, to control the first sticker classification identifier, for example, display, delete, or move the first sticker classification identifier, so that sticker classification identifiers in the sticker panel are flexibly controlled with respect to the disadvantage in the existing technology that stickers in an instant messaging service cannot be flexibly controlled, so as to achieve the technical effect of improving the flexibility of controlling the sticker classification identifiers, thereby resolving the technical problem in the existing technology that the flexibility of controlling a sticker classification identifier is relatively poor.

### BRIEF DESCRIPTION OF THE DRAWINGS

The accompanying drawings described herein are used to provide further understanding of the present disclosure and constitute one part of this application. Exemplary embodiments of the present disclosure and descriptions thereof are used to explain the present disclosure, and do not constitute an inappropriate limitation to the present disclosure. In the figures:

FIG. 1 is an architectural diagram of a hardware structure according to an embodiment of the present disclosure;

FIG. 2 is a schematic diagram of a display interface of a sticker panel in the related technology;

FIG. 3 is a flowchart of a method for controlling a sticker classification identifier according to this embodiment of the present disclosure;

FIG. 4 is a schematic diagram of an optional display interface of a sticker panel according to this embodiment of the present disclosure;

FIG. 5 is a schematic diagram of another optional display interface of a sticker panel according to this embodiment of the present disclosure;

FIG. 6 is a schematic diagram of still another optional display interface of a sticker panel according to this embodiment of the present disclosure;

FIG. 7 is a schematic diagram of yet another optional display interface of a sticker panel according to this embodiment of the present disclosure;

FIG. 8 is a schematic diagram of still yet another optional display interface of a sticker panel according to this embodiment of the present disclosure;

FIG. 9 is a schematic diagram of a still further optional display interface of a sticker panel according to this embodiment of the present disclosure;

FIG. 10 is a schematic diagram of an apparatus for controlling a sticker classification identifier according to an embodiment of the present disclosure; and

FIG. 11 is a structural diagram of hardware of a terminal according to an embodiment of the present disclosure.

### DESCRIPTION OF EMBODIMENTS

To enable a person skilled in the art to better understand the solutions of the present disclosure, the following clearly and completely describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

It should be noted that in the specification, the claims, and the accompanying drawings of the present disclosure, the terms “first”, “second”, and so on are intended to distinguish between similar objects, rather than indicate a specific order or a time order. It should be understood that such used data can be exchanged with each other in appropriate cases, so that the embodiments of the present disclosure that are described herein can be implemented in a sequence other than the sequences shown in the figures or described herein. Moreover, the terms “include”, “have” and any variant thereof mean to cover the non-exclusive inclusion. For example, in the context of a process, method, system, product or device that includes a series of steps or units, the process, method, system, product or device is not necessarily limited to the clearly listed steps or units, and instead, includes other steps or units not specified clearly, or may include inherent steps or units of the process, method, product, or device.

### Embodiment 1

According to an embodiment of the present disclosure, a method embodiment that may be implemented by an apparatus embodiment of this application is provided. It should be noted that steps shown in the flowchart of the accompanying drawing may be performed, for example, in a computer system storing a group of computer executable instructions, and in addition, although a logic sequence is shown in the flowchart, in some cases, the shown or described steps may be performed in a sequence different from that described herein.

According to this embodiment of the present disclosure, a method for controlling a sticker classification identifier is provided.

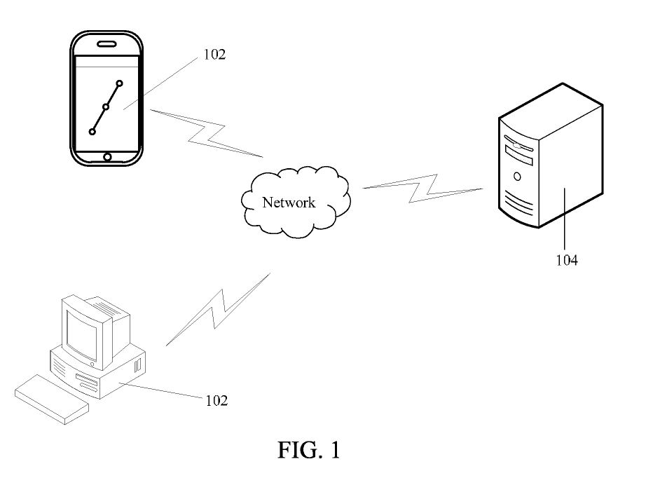

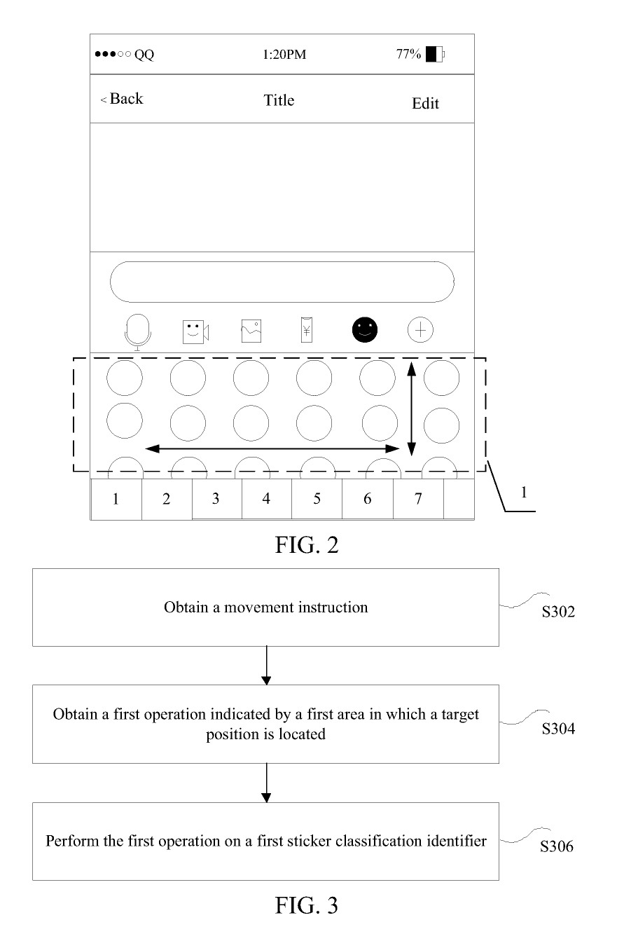

In some embodiments, the method for controlling a sticker classification identifier may be applied to a hardware environment formed by a computing device 102 and a server 104 shown in FIG. 1. As shown in FIG. 1, the computing device 102 is connected to the server 104 by using a network. The network includes but is not limited to: a mobile communications network, a wide area network, a metropolitan area network, or a local area network. The computing device 102 may be a mobile phone terminal, a PC terminal, a notebook terminal, or a tablet computer terminal.

FIG. 3 is a flowchart of a method for controlling a sticker classification identifier according to this embodiment of the present disclosure. The computing device 102 first displays an instant messaging user interface. As shown in FIG. 3, the instant messaging user interface includes a user input region and a plurality of messaging options, e.g., an audio messaging option, a video messaging option, a sticker messaging option, etc. After detecting a user selection of the sticker messaging option, the computing device 102 updates the instant messaging user interface by displaying a sticker panel below the user input region, the sticker panel including one or more sticker classification identifiers, each sticker classification identifier further including one or more stickers. As shown in FIG. 3, the sticker messaging option is displayed in the instant messaging user interface in a manner that is visually distinguishable from the audio messaging option and the video messaging option.

As shown in FIG. 3, the method for controlling a sticker classification identifier mainly includes the following step S302 to step S306:

Step S302: Obtain a movement instruction to be applied to a first sticker classification identifier of the one or more sticker classification identifiers, the movement instruction being used to move a first sticker classification identifier on a sticker panel to a target position, the sticker panel displaying one or more sticker classification identifiers including the first sticker classification identifier, and the first sticker classification identifier including one or more stickers.

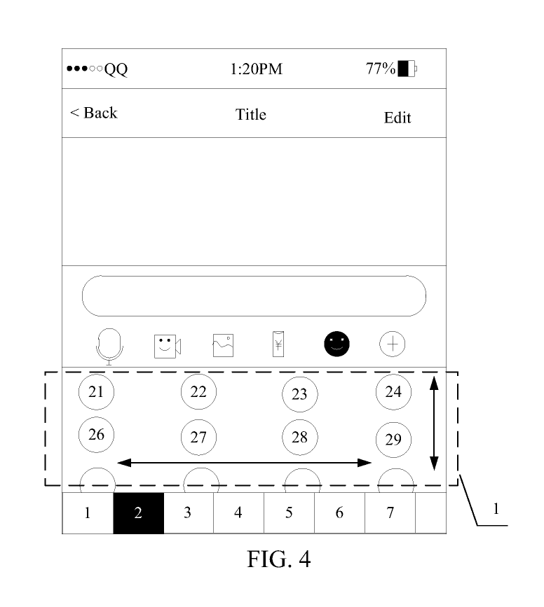

As shown in FIG. 4, a sticker panel 1 includes a plurality of sticker classification identifiers, which are respectively a sticker classification identifier 1 to a sticker classification identifier 7. Each sticker classification identifier includes one or more stickers. For example, as shown in FIG. 4, when a user selects a sticker classification identifier 2 from the sticker panel 1, a plurality of stickers (for example, stickers represented by a reference sign 21 to a reference sign 29 in FIG. 4) are displayed in the sticker panel. The stickers may be dynamic icons, or may be static icons. In FIG. 4, the stickers displayed by the reference sign 21 to the reference sign 28 are merely some of stickers included in the sticker classification identifier 2. Other stickers that are not displayed or not completely displayed and included in the sticker classification identifier 2 may be displayed by means of sliding upwards, downwards, leftwards, or downwards.

It should be noted that in a sticker classification identifier list shown in FIG. 4, on a right side of the sticker classification identifier 7, there may be one or more sticker classification identifiers that are not completely displayed.

The movement instruction may be a touch and hold instruction, for example, an instruction that the user touches and holds the sticker classification identifier 2 in a terminal device. After the terminal device obtains the touch and hold instruction, the sticker classification identifier 2 may be moved from a position at which the sticker classification identifier 2 is currently located until the sticker classification identifier 2 is moved to a target position.

Step S304: Obtain a first operation indicated by a first area in which the target position is located.

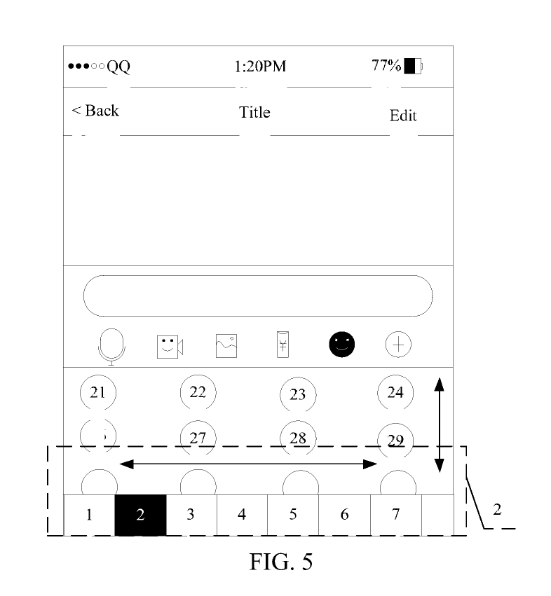

An interface shown in FIG. 5 is an optional display interface of an instant messaging service (for example, QQ or WeChat) in the terminal device. First operations indicated by different areas in the interface shown in FIG. 5 are different. For example, if the sticker classification identifier 2 is moved to an area represented by a dashed line box in FIG. 5, a first operation indicated by the area 2 may be an operation of moving the sticker classification identifier 2 to another position in the sticker classification identifier list. That is, in this area, the sticker classification identifier 2 may be moved from a current initial area to an area in which another sticker classification identifier is located, for example, an area in which the sticker classification identifier 7 is located. For another example, if the sticker classification identifier 2 is moved to an area 3 or an area 4, a first operation indicated by the area 3 may be an operation of deleting the sticker classification identifier 2, and the first operation indicated by the area 4 may also be an operation of deleting the sticker classification identifier 2. The area 3 and the area 4 are areas outside the area 2, and are not shown in FIG. 5. The first operations indicated by the area 2 to the area 4 may be same operations or may be different operations.

It should be noted that in this embodiment of the present disclosure, only the area 2 to the area 4 and the first operations indicated by the area 2 to the area 4 are used as examples for description. The interface shown in FIG. 5 further includes other first areas and first operations indicated by the first areas.

Step S306: Perform the first operation on the first sticker classification identifier.

If an area in which the sticker classification identifier 2 is located is an area between any two adjacent sticker classification identifiers (for example, a sticker classification identifier 6 and a sticker classification identifier 4) in the area 2, when the user releases the sticker classification identifier 2, that is, when the instruction of touching and holding the sticker classification identifier 2 ends, the corresponding first operation may be performed on the sticker classification identifier 2. For example, the sticker classification identifier 2 is moved to the position in which the sticker classification identifier 7 in the sticker classification identifier list is located.

If the target position of the sticker classification identifier 2 after movement is located in the area 3 or the area 4, when the user releases the sticker classification identifier 2, that is, when the instruction of touching and holding the sticker classification identifier 2 ends, the corresponding first operation is performed on the sticker classification identifier 2. For example, the sticker classification identifier 2 is deleted from the sticker classification identifier list.

In this embodiment of the present disclosure, a corresponding operation is performed on the first sticker classification identifier that is moved to the target position and in the sticker panel, to control the first sticker classification identifier, for example, display, delete, or move the first sticker classification identifier, so that sticker classification identifiers in the sticker panel are flexibly controlled with respect to the disadvantage in the existing technology that stickers in an instant messaging service cannot be flexibly controlled, so as to achieve the technical effect of improving the flexibility of controlling the sticker classification identifiers, thereby resolving the technical problem in the existing technology that the flexibility of controlling a sticker classification identifier is relatively poor.

In this embodiment of the present disclosure, after the movement instruction is obtained, the first sticker classification identifier may further be controlled to move from the initial area in the sticker classification identifier list to the first area, and other sticker classification identifiers, other than the first sticker classification identifier, in the sticker classification identifier list are controlled to move in sequence according to a direction pointing to the initial area.

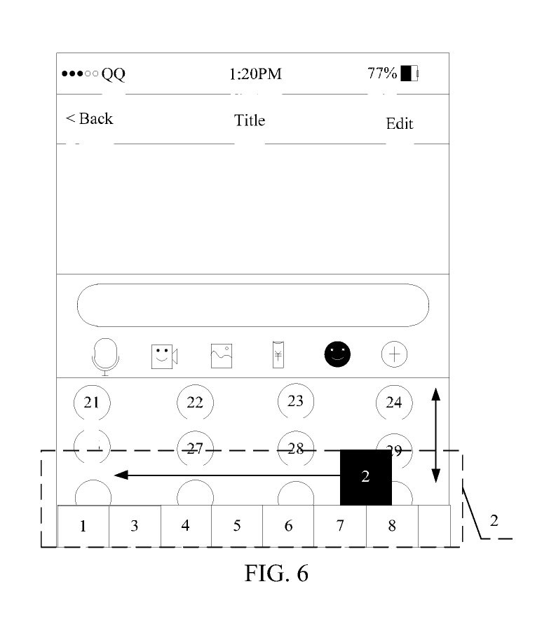

As shown in FIG. 4, FIG. 5, and FIG. 6, areas in which the sticker classification identifier 1 to the sticker classification identifier 7 are located are the sticker classification identifier list.

After obtaining the instruction that the user touches and holds the first sticker classification identifier, the terminal device may control the first sticker classification identifier to move from the initial area of the first sticker classification identifier to the target position of the first area. The initial area of the first sticker classification identifier after movement is in an idle state, and does not display any sticker classification identifier. In this case, the other sticker classification identifiers, other than the first sticker classification identifier, in the sticker classification identifier list may be moved in sequence by one position according to the direction pointing to the initial area.

For example, FIG. 4 shows initial areas in which all the sticker classification identifiers in the sticker classification identifier list are located before the first sticker classification identifier is moved. At the moment when the sticker classification identifier 2 is moved out of the initial area, the initial area in which the sticker classification identifier 2 is located does not display any sticker classification identifier. Subsequently, the sticker classification identifier 3 to the sticker classification identifier 7 on a right side of the sticker classification identifier 2 may be moved leftwards in sequence by one position. For example, as shown in FIG. 6, the sticker classification identifier 3 is moved to the initial area of the sticker classification identifier 2, the sticker classification identifier 4 is moved to the initial area of the sticker classification identifier 3, and the like. The sticker classification identifier 1 on the left side of the sticker classification identifier 2 may alternatively be moved rightwards by one position. That is, the sticker classification identifier 1 is moved to the initial area of the sticker classification identifier 2 (not shown in FIG. 6).

In some embodiments, after the other sticker classification identifiers, other than the first sticker classification identifier, in the sticker classification identifier list are controlled to move in sequence according to the direction pointing to the initial area, whether the quantity of the other sticker classification identifiers is less than the quantity of areas, for displaying the sticker classification identifiers, in the sticker classification identifier list may further be determined. If the quantity of the other sticker classification identifiers is less than the quantity of the areas, for displaying the sticker classification identifiers, in the sticker classification identifier list, an area, which does not display a sticker classification identifier, in the sticker classification identifier list is displayed as an idle area. If the quantity of the other sticker classification identifiers is greater than or equal to the quantity of the areas, for displaying the sticker classification identifiers, in the sticker classification identifier list, a second sticker classification identifier is displayed in the sticker classification identifier list. The second sticker classification identifier is not displayed in the sticker classification identifier list before the first sticker classification identifier is moved.

After the sticker classification identifier 3 to the sticker classification identifier 7 are moved leftwards in sequence by one position, whether the sticker classification identifier list includes other sticker classification identifiers in addition to the sticker classification identifier 1, and the sticker classification identifier 3 to the sticker classification identifier 7 may be determined. If it is determined that the sticker classification identifier list further includes other sticker classification identifiers, for example, an sticker classification identifier 8 and a sticker classification identifier 9, in this case, the sticker classification identifier 8 may be displayed in the sticker classification identifier list. The sticker classification identifier 8 is adjacent to the sticker classification identifier 7. If it is determined that the sticker classification identifier list does not include other sticker classification identifiers, in this case, the area, which does not display a sticker classification identifier, in the sticker classification identifier list may be displayed as the idle area. That is, the initial area of the sticker classification identifier 7 is displayed as the idle area. Specifically, as shown in FIG. 6, after the sticker classification identifier 2 is moved out of the sticker classification identifier list, and the sticker classification identifier 3 to the sticker classification identifier 7 are moved leftwards in sequence by one position, the sticker classification identifier 8 may be moved to the initial area of the sticker classification identifier 7 and displayed in the sticker classification identifier list.

Alternatively, after the sticker classification identifier 1 is moved to the initial area of the sticker classification identifier 2, if it is determined that the sticker classification identifier list includes other sticker classification identifiers in addition to the sticker classification identifier 1, and the sticker classification identifier 3 to the sticker classification identifier 7, in this case, a sticker classification identifier adjacent to the sticker classification identifier 1 may further be displayed in the initial area of the sticker classification identifier 1. The sticker classification identifier currently displayed in the initial area of the sticker classification identifier 1 is not displayed in the sticker classification identifier list before the sticker classification identifier 2 is moved. If it is determined that the sticker classification identifier list does not include other sticker classification identifiers, the initial area of the sticker classification identifier 1 may be displayed as the idle area.

It should be noted that due to normal habits of people, an area that does not display a sticker classification identifier is displayed and disposed at a position on a right side in the sticker classification identifier list. Therefore, when the quantity of the other sticker classification identifiers is less than the quantity of the areas, for displaying the sticker classification identifiers, in the sticker classification identifier list, the sticker classification identifier 1, and the sticker classification identifier 3 to the sticker classification identifier 7 may be controlled to move leftwards in sequence after the initial area of the sticker classification identifier 1 is displayed as the idle area, so that the initial area of the sticker classification identifier 7 becomes the idle area.

In some embodiments, the performing the first operation on the first sticker classification identifier may be specifically: determining whether the first area includes a second area in which any two adjacent sticker classification identifiers in the sticker classification identifier list are located; if it is determined that the first area includes the second area in the sticker classification identifier list, displaying the idle area between the two adjacent sticker classification identifiers when the first sticker classification identifier partially or completely overlaps with the second area; and moving the first sticker classification identifier to the idle area.

The second area may be the area in which any two adjacent sticker classification identifiers in the sticker classification identifier list are located. For example, as shown in FIG. 6, an area in which the sticker classification identifier 7 and the sticker classification identifier 8 adjacent thereto are located is the second area.

If the first area in which the sticker classification identifier 2 is located after movement is the area 2, it may be determined that the area 2 (that is, the first area) includes the area (that is, the second area) in which the sticker classification identifier 7 and the sticker classification identifier 8 are located. In this case, if the sticker classification identifier 2 is about to be attached to the second area or overlap with the second area (for example, an area in which the sticker classification identifier 2 is located in FIG. 6), the idle area represented by a reference sign 7′ is displayed between the sticker classification identifier 7 and the sticker classification identifier 8. The area represented by the reference sign 7′ is the initial area in which the sticker classification identifier 7 is located, and the idle area indicates that the area does not display any sticker classification identifier. When the user releases the sticker classification identifier 2, the sticker classification identifier 2 will be released to the idle area represented by the reference sign 7′.

It should be noted that in this embodiment of the present disclosure, the idle area is not limited to the initial area in which the sticker classification identifier 8 is located in FIG. 6. The initial area in which the sticker classification identifier 7 is located in FIG. 6 may alternatively be displayed as the idle area. Specifically, if ½ of the sticker classification identifier 2 overlaps with the sticker classification identifier 7, and ½ of the sticker classification identifier 2 overlaps with the sticker classification identifier 8, the initial area in which the sticker classification identifier 8 is located in FIG. 6 may be displayed as the idle area. If a part, overlapping with the sticker classification identifier 7, in the sticker classification identifier 2 is greater than ½ of the sticker classification identifier 2, the initial area in which the sticker classification identifier 7 is located in FIG. 6 may be displayed as the idle area. If a part, overlapping with the sticker classification identifier 8, in the sticker classification identifier 2 is greater than ½ of the sticker classification identifier 2, the initial area in which the sticker classification identifier 8 is located in FIG. 6 may be displayed as the idle area.

In this embodiment of the present disclosure, the idle area may be displayed between two adjacent sticker classification identifiers in the following three manners:

Manner 1:

Control a sticker classification identifier on a first side of the first sticker classification identifier located at the target position to move to a first direction, where the first direction is a direction from the first sticker classification identifier to the sticker classification identifier on the first side.

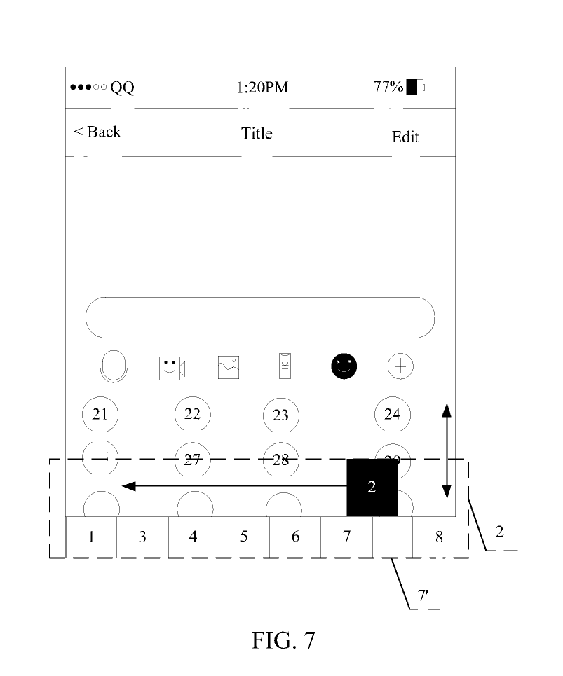

Assuming that the first sticker classification identifier is the sticker classification identifier 2, when the target position of the sticker classification identifier 2 is a position of the sticker classification identifier 2 shown in FIG. 6, the sticker classification identifier on the first side of the sticker classification identifier 2 may be a sticker classification identifier on the right side of the sticker classification identifier 2, that is, the sticker classification identifier 8. In this case, the sticker classification identifier 8 may be controlled to move to the right side by one position, to obtain the idle area represented by the reference sign 7′ shown in FIG. 7. The first position is a position on the right side of the sticker classification identifier 2 located at the target position.

Manner 2:

Control a sticker classification identifier on a second side of the first sticker classification identifier located at the target position to move to a second direction, where the second direction is a direction from the first sticker classification identifier to the sticker classification identifier on the second side, and the first direction is opposite to the second direction.

Assuming that the first sticker classification identifier is the sticker classification identifier 2, when the target position of the sticker classification identifier 2 is the position of the sticker classification identifier 2 shown in FIG. 6, the sticker classification identifier on the second side of the sticker classification identifier 2 may be a sticker classification identifier on the left side of the sticker classification identifier 2, that is, the sticker classification identifier 1, and the sticker classification identifier 3 to the sticker classification identifier 7. In this case, the sticker classification identifier 7 may be controlled to move to the left side by one position, to obtain the area represented by the reference sign 7′ shown in FIG. 7. The second direction is a position on the left side of the sticker classification identifier 2 located at the target position.

Manner 3:

Control the sticker classification identifier on the first side of the first sticker classification identifier located at the target position to move to the first direction, where the first direction is the direction from the first sticker classification identifier to the sticker classification identifier on the first side; and

Control the sticker classification identifier on the second side of the first sticker classification identifier located at the target position to move to the second direction, where the second direction is the direction from the first sticker classification identifier to the sticker classification identifier on the second side, and the first direction is opposite to the second direction.

In this embodiment of the present disclosure, the sticker classification identifier 8 may alternatively be controlled to move to the right side by a half position, and the sticker classification identifier 1, and the sticker classification identifier 3 to the sticker classification identifier 7 are controlled to move to the left side by a half position, to obtain the area represented by the reference sign 7′ shown in FIG. 7. The first direction is a rightward direction, and the second direction is a leftward direction.

In some embodiments, when the first operation is to move the first sticker classification identifier to the idle area, the first sticker classification identifier is deleted when the first sticker classification identifier is moved to an area outside the first area.

If the first sticker classification identifier is moved from the area represented by the area 2 (that is, the first area) to an area outside the area 2, after the user releases the first sticker classification identifier, the first sticker classification identifier may be deleted, and a plurality of stickers included in the first sticker classification identifier may also be deleted.

In some embodiments, after the movement instruction is obtained, the first sticker classification identifier may further be enlarged to obtain an enlarged first sticker classification identifier, and the enlarged first sticker classification identifier is displayed.

As shown in FIG. 6 and FIG. 7, after the user touches and holds the sticker classification identifier 2, the sticker classification identifier 2 may be enlarged, and the enlarged sticker classification identifier 2 is displayed in the sticker panel, to prompt the user that related operations are currently performed on the sticker classification identifier 2.

In some embodiments, the performing the first operation on the first sticker classification identifier may alternatively be: deleting the first sticker classification identifier from the first area, where when the first sticker classification identifier is deleted, the plurality of stickers included in the first sticker classification identifier are deleted from the sticker classification identifier list.

A deletion icon is displayed in the first area. The deleting the first sticker classification identifier from the first area may be: when the first sticker classification identifier is moved to the deletion icon, controlling a display color of the deletion icon to be gradually darkened, and when the first sticker classification identifier is located in a preset area in which the deletion icon is located, controlling the deletion icon to turn from a first icon into a second icon.

The first sticker classification identifier not only can be moved as stated above, but also can be deleted. There may be a plurality of methods for deleting the first sticker classification identifier. In this embodiment of the present disclosure, the first sticker classification identifier may be moved to the area 3 or the area 4 (that is, the first area), because the first operation performed in the area 3 or the area 4 may be an operation of deleting the first sticker classification identifier.

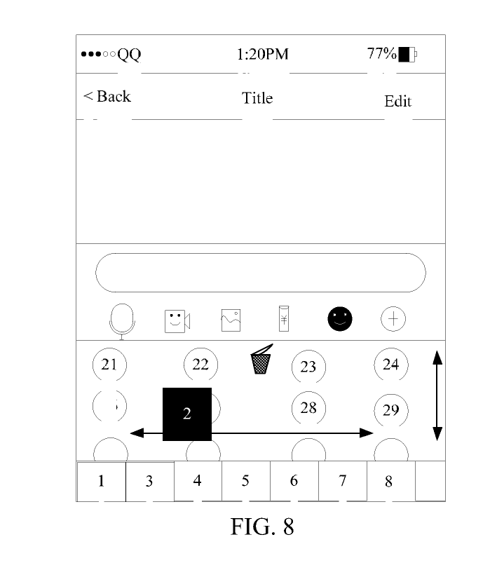

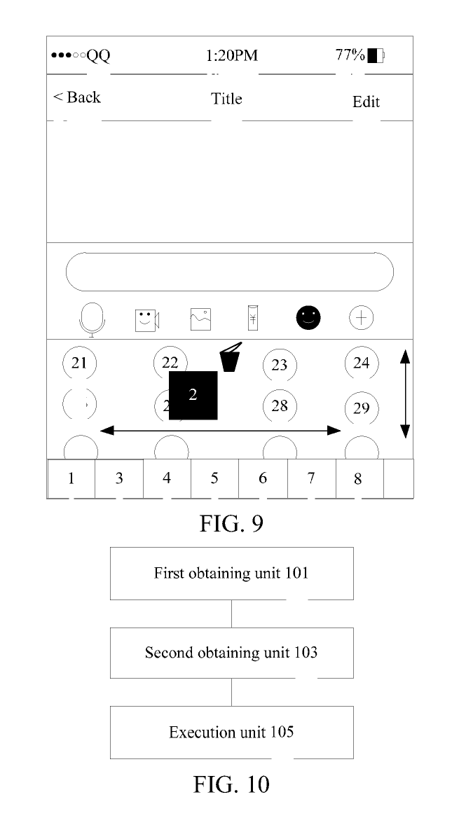

If the first sticker classification identifier is moved to the area 4, a deletion icon may be displayed in the area 4. The shape of the deletion icon may be the shape of a trash. When the first sticker classification identifier is moved to the area 4 and approaches to the deletion icon, the color of the deletion icon is gradually darkened, and the deletion icon is controlled to turn from the first icon into the second icon when the first sticker classification identifier is located in an area in which the deletion icon is located (that is, the preset area). As shown in FIG. 8 and FIG. 9, the first sticker classification identifier (that is, the sticker classification identifier 2) in FIG. 9 is closer to the deletion icon than the first sticker classification identifier (that is, the sticker classification identifier 2) in FIG. 8. Therefore, the display color of the deletion icon in FIG. 9 is darker than that of the deletion icon in FIG. 8, and the forms of the deletion icons in FIG. 9 and FIG. 8 are also different. The opening angle of a cover of the trash (that is, the deletion icon) in FIG. 8 is relatively small (that is, the first icon), and the opening angle of a cover of the trash (that is, the deletion icon) in FIG. 9 is relatively large (that is, the second icon).

In this embodiment of the present disclosure, the sequence of the sticker classification identifiers in the sticker classification identifier list are adjusted in manner such as touching and holding, dragging, and releasing, or the sticker classification identifiers in the sticker classification identifier list are deleted. Therefore, by using the method for controlling a sticker classification identifier provided in the foregoing embodiment of the present disclosure, the user may be enabled to freely adjust the sequence of stickers, so that the user can quickly call corresponding stickers. Correspondingly, time for sending a message by the user is saved, thereby improving the user experience.

It should be noted that for the foregoing method embodiments, for ease of description, the method embodiments are all described into a series of action combinations. However, a person skilled in the art should know that the present disclosure is not limited by a sequence of described actions because according to the present disclosure, some steps may be performed in other sequences or may be simultaneously performed. Secondly, a person skilled in the art should also know that the embodiments described in this specification are all preferred embodiments, and actions and modules involved in this description are not necessarily mandatory in the embodiments of the present disclosure.

By means of the description of the foregoing implementation, a person skilled in the art can clearly learn that the method according to the foregoing embodiment may be implemented by means of software plus necessary general-purpose hardware platforms, and certainly, may alternatively be implemented by hardware. However, in many cases, the former is a better implementation. Based on such an understanding, the technical solutions of the present disclosure essentially, or the part contributing to the existing technology may be implemented in a form of a software product. The computer software product is stored in a storage medium (such as a read-only memory (ROM)/random access memory (RAM), a magnetic disk, or an optical disc) and includes several instructions for instructing a terminal device (which may be a mobile phone, a computer, a server, a network device, or the like) to perform the methods described in the embodiments of the present disclosure.

### Embodiment 2

According to an embodiment of the present disclosure, an apparatus for controlling a sticker classification identifier and for performing the foregoing method for controlling a sticker classification identifier is further provided. The apparatus for controlling a sticker classification identifier is mainly configured to perform the method for controlling a sticker classification identifier and provided in the foregoing content of the embodiments of the present disclosure. The apparatus for controlling a sticker classification identifier provided in this embodiment of the present disclosure is described in detail below:

FIG. 10 is a schematic diagram of an apparatus for controlling a sticker classification identifier according to this embodiment of the present disclosure. As shown in FIG. 10, the apparatus for controlling a sticker classification identifier mainly includes: a first obtaining unit 101, a second obtaining unit 103, and an execution unit 105.

The first obtaining unit 101 is configured to obtain a movement instruction, the movement instruction being used to move a first sticker classification identifier on a sticker panel to a target position, the sticker panel displaying one or more sticker classification identifiers including the first sticker classification identifier, and the first sticker classification identifier including one or more stickers.

As shown in FIG. 4, a sticker panel 1 includes a plurality of sticker classification identifiers, which are respectively a sticker classification identifier 1 to a sticker classification identifier 7. Each sticker classification identifier includes one or more stickers. For example, as shown in FIG. 4, when a user selects a sticker classification identifier 2 from the sticker panel 1, a plurality of stickers (for example, stickers represented by a reference sign 21 to a reference sign 28 in FIG. 4) are displayed in the sticker panel. The stickers may be dynamic icons, or may be static icons. In FIG. 4, the stickers displayed by the reference sign 21 to the reference sign 28 are merely some of stickers included in the sticker classification identifier 2. Other stickers that are not displayed or not completely displayed and included in the sticker classification identifier 2 may be displayed by means of sliding upwards, downwards, leftwards, or downwards.

It should be noted that in a sticker classification identifier list shown in FIG. 4, on a right side of the sticker classification identifier 7, there may be one or more sticker classification identifiers that are not completely displayed.

The movement instruction may be a touch and hold instruction, for example, an instruction that the user touches and holds the sticker classification identifier 2 in a terminal device. After the terminal device obtains the touch and hold instruction, the sticker classification identifier 2 may be moved from a position at which the sticker classification identifier 2 is currently located until the sticker classification identifier 2 is moved to a target position.

The second obtaining unit 103 is configured to obtain a first operation indicated by a first area in which the target position is located.

An interface shown in FIG. 5 is an optional display interface of an instant messaging service (for example, QQ or WeChat) in the terminal device. First operations indicated by different areas in the interface shown in FIG. 5 are different. For example, if the sticker classification identifier 2 is moved to an area represented by a dashed line box in FIG. 5, a first operation indicated by the area 2 may be an operation of moving the sticker classification identifier 2 to another position in the sticker classification identifier list. That is, in this area, the sticker classification identifier 2 may be moved from a current initial area to an area in which another sticker classification identifier is located, for example, an area in which the sticker classification identifier 7 is located. For another example, if the sticker classification identifier 2 is moved to an area 3 or an area 4, a first operation indicated by the area 3 may be an operation of deleting the sticker classification identifier 2, and the first operation indicated by the area 4 may also be an operation of deleting the sticker classification identifier 2. The area 3 and the area 4 are areas outside the area 2, and are not shown in FIG. 5. The first operations indicated by the area 2 to the area 4 may be same operations or may be different operations.

It should be noted that in this embodiment of the present disclosure, only the area 2 to the area 4 and the first operations indicated by the area 2 to the area 4 are used as examples for description. The interface shown in FIG. 5 further includes other first areas and first operations indicated by the first areas.

The execution unit 105 is configured to perform the first operation on the first sticker classification identifier.

If an area in which the sticker classification identifier 2 is located is an area between any two adjacent sticker classification identifiers (for example, a sticker classification identifier 6 and a sticker classification identifier 4) in the area 2, when the user releases the sticker classification identifier 2, that is, when the instruction of touching and holding the sticker classification identifier 2 ends, the corresponding first operation may be performed on the sticker classification identifier 2. For example, the sticker classification identifier 2 is moved to the position in which the sticker classification identifier 7 in the sticker classification identifier list is located.

If the target position of the sticker classification identifier 2 after movement is located in the area 3 or the area 4, when the user releases the sticker classification identifier 2, that is, when the instruction of touching and holding the sticker classification identifier 2 ends, the corresponding first operation is performed on the sticker classification identifier 2. For example, the sticker classification identifier 2 is deleted from the sticker classification identifier list.

If the target position of the sticker classification identifier 2 after movement is located in the area 3 or the area 4, when the user releases the sticker classification identifier 2, that is, when the instruction of touching and holding the sticker classification identifier 2 ends, the corresponding first operation is performed on the sticker classification identifier 2. For example, the sticker classification identifier 2 is deleted from the sticker classification identifier list.

In this embodiment of the present disclosure, a corresponding operation is performed on the first sticker classification identifier that is moved to the target position and in the sticker panel, to control the first sticker classification identifier, for example, display, delete, or move the first sticker classification identifier, so that sticker classification identifiers in the sticker panel are flexibly controlled with respect to the disadvantage in the existing technology that stickers in an instant messaging service cannot be flexibly controlled, so as to achieve the technical effect of improving the flexibility of controlling the sticker classification identifiers, thereby resolving the technical problem in the existing technology that the flexibility of controlling a sticker classification identifier is relatively poor.

In some embodiments, the execution unit includes: a determining module, configured to determine whether the first area includes a second area in which any two adjacent sticker classification identifiers in a sticker classification identifier list are located; a display module, configured to: if it is determined that the first area includes the second area in the sticker classification identifier list, display an idle area between the two adjacent sticker classification identifiers when the first sticker classification identifier partially or completely overlaps with the second area; and a movement module, configured to move the first sticker classification identifier to the idle area.

In some embodiments, the display module includes: a first control submodule, configured to control a sticker classification identifier on a first side of the first sticker classification identifier located at the target position to move to a first direction, where the first direction is a direction from the first sticker classification identifier to the sticker classification identifier on the first side; and/or a second control submodule, configured to control a sticker classification identifier on a second side of the first sticker classification identifier located at the target position to move to a second direction, where the second direction is a direction from the first sticker classification identifier to the sticker classification identifier on the second side, and the first direction is opposite to the second direction

In some embodiments, the apparatus further includes: a deletion unit, configured to: when the first operation is to move the first sticker classification identifier to the idle area, delete the first sticker classification identifier when the first sticker classification identifier is moved to an area outside the first area.

In some embodiments, the apparatus further includes: a first control unit, configured to control the first sticker classification identifier to move from an initial area in the sticker classification identifier list to the first area after the movement instruction is obtained; and a second control unit, configured to control other sticker classification identifiers, other than the first sticker classification identifier, in the sticker classification identifier list to move in sequence according to a direction pointing to the initial area.

In some embodiments, the apparatus further includes: a determining unit, configured to: after the other sticker classification identifiers, other than the first sticker classification identifier, in the sticker classification identifier list are controlled to move in sequence according to the direction pointing to the initial area, determine whether the quantity of the other sticker classification identifiers is less than the quantity of areas, for displaying sticker classification identifiers, in the sticker classification identifier list; a first display unit, configured to: if the quantity of the other sticker classification identifiers is less than the quantity of the areas, for displaying the sticker classification identifiers, in the sticker classification identifier list, display an area, which does not display a sticker classification identifier, in the sticker classification identifier list as an idle area; and a second display unit, configured to: if the quantity of the other sticker classification identifiers is greater than or equal to the quantity of the areas, for displaying the sticker classification identifiers, in the sticker classification identifier list, display a second sticker classification identifier in the sticker classification identifier list, where the second sticker classification identifier is not displayed in the sticker classification identifier list before the first sticker classification identifier is moved.

In some embodiments, the apparatus further includes: an enlargement unit, configured to: after the movement instruction is obtained, enlarge the first sticker classification identifier, to obtain an enlarged first sticker classification identifier; and a third display unit, configured to display the enlarged first sticker classification identifier.

In some embodiments, the execution unit includes: a deletion module, configured to delete the first sticker classification identifier from the first area, where when the first sticker classification identifier is deleted, the plurality of stickers included in the first sticker classification identifier are deleted from the sticker classification identifier list.

In some embodiments, a deletion icon is displayed in the first area. The deletion module includes: a third control submodule, configured to: when the first sticker classification identifier is moved to the deletion icon, control a display color of the deletion icon to be gradually darkened, and when the first sticker classification identifier is located in a preset area in which the deletion icon is located, control the deletion icon to turn from a first icon into a second icon.

### Embodiment 3

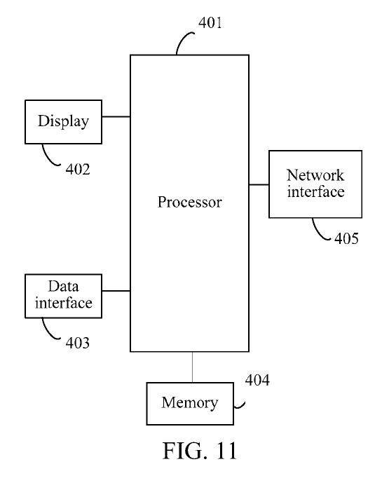

According to an embodiment of the present disclosure, a mobile terminal for performing the foregoing method for controlling a sticker classification identifier is further provided. As shown in FIG. 11, the mobile terminal mainly includes a processor 401, a display 402, a data interface 403, a memory 404, and a network interface 405.

The display 402 is mainly configured to display a sticker panel. The sticker panel includes a sticker classification identifier.

The data interface 403 is configured to transmit, by means of data transmission, a sticker classification identifier selected by a user to the processor 401.

The memory 404 is mainly configured to store a related record of moving or deleting a sticker classification identifier.

The network interface 405 is mainly configured to: perform network communication with a server and provide data support for controlling a sticker classification identifier.

The processor 401 is mainly configured to perform the following operations:

obtaining a movement instruction, the movement instruction being used to move a first sticker classification identifier on a sticker panel to a target position, the sticker panel displaying one or more sticker classification identifiers including the first sticker classification identifier, and the first sticker classification identifier including one or more stickers; obtaining a first operation indicated by a first area in which the target position is located; and performing the first operation on the first sticker classification identifier.

The processor 401 is further configured to: determine whether the first area includes a second area in which any two adjacent sticker classification identifiers in a sticker classification identifier list are located; if it is determined that the first area includes the second area in the sticker classification identifier list, display an idle area between the two adjacent sticker classification identifiers when the first sticker classification identifier partially or completely overlaps with the second area; and move the first sticker classification identifier to the idle area.

The processor 401 is further configured to: control a sticker classification identifier on a first side of the first sticker classification identifier located at the target position to move to a first direction, where the first direction is a direction from the first sticker classification identifier to the sticker classification identifier on the first side; and/or control a sticker classification identifier on a second side of the first sticker classification identifier located at the target position to move to a second direction, where the second direction is a direction from the first sticker classification identifier to the sticker classification identifier on the second side, and the first direction is opposite to the second direction.

The processor 401 is further configured to: when the first operation is to move the first sticker classification identifier to the idle area, delete the first sticker classification identifier when the first sticker classification identifier is moved to an area outside the first area.

The processor 401 is further configured to: control the first sticker classification identifier to move from an initial area in the sticker classification identifier list to the first area after the movement instruction is obtained; and control other sticker classification identifiers, other than the first sticker classification identifier, in the sticker classification identifier list to move in sequence according to a direction pointing to the initial area.

The processor 401 is further configured to: after the other sticker classification identifiers, other than the first sticker classification identifier, in the sticker classification identifier list are controlled to move in sequence according to the direction pointing to the initial area, determine whether the quantity of the other sticker classification identifiers is less than the quantity of areas, for displaying sticker classification identifiers, in the sticker classification identifier list; if the quantity of the other sticker classification identifiers is less than the quantity of the areas, for displaying the sticker classification identifiers, in the sticker classification identifier list, display an area, which does not display a sticker classification identifier, in the sticker classification identifier list as an idle area; and if the quantity of the other sticker classification identifiers is greater than or equal to the quantity of the areas, for displaying the sticker classification identifiers, in the sticker classification identifier list, display a second sticker classification identifier in the sticker classification identifier list, where the second sticker classification identifier is not displayed in the sticker classification identifier list before the first sticker classification identifier is moved.

The processor 401 is further configured to: after the movement instruction is obtained, enlarge the first sticker classification identifier, to obtain an enlarged first sticker classification identifier; and display the enlarged first sticker classification identifier.

The processor 401 is further configured to delete the first sticker classification identifier from the first area, where when the first sticker classification identifier is deleted, the plurality of stickers included in the first sticker classification identifier are deleted from the sticker classification identifier list.

The processor 401 is further configured to: when the first sticker classification identifier is moved to the deletion icon, control a display color of the deletion icon to be gradually darkened, and when the first sticker classification identifier is located in a preset area in which the deletion icon is located, control the deletion icon to turn from a first icon into a second icon.

In some embodiments, reference may be made to examples described in the Embodiment 1 and Embodiment 2 for specific examples in this embodiment, and details are not described herein again.

### Embodiment 4

An embodiment of the present disclosure further provides a storage medium. In some embodiments, the storage medium may be used to store program codes for performing the methods for controlling a sticker classification identifier of the embodiments of the present disclosure.

In some embodiments, the storage medium may be located in at least one of a plurality of network devices in a mobile communications network, a wide area network, a metropolitan area network, or a local area network.

In some embodiments, the storage medium is configured to store program codes for performing the following steps:

S1: Obtain a movement instruction, the movement instruction being used to move a first sticker classification identifier on a sticker panel to a target position, the sticker panel displaying one or more sticker classification identifiers including the first sticker classification identifier, and the first sticker classification identifier including one or more stickers.

S2: Obtain a first operation indicated by a first area in which the target position is located.

S3: Perform the first operation on the first sticker classification identifier.

In some embodiments, the foregoing storage medium may include but is not limited to: various media that can store program codes such as a USB flash drive, a ROM, a RAM, a removable hard disk, a magnetic disk, or an optical disc.

In some embodiments, reference may be made to examples described in the Embodiment 1 and Embodiment 2 for specific examples in this embodiment, and details are not described herein again.

The sequence numbers of the foregoing embodiments of the present disclosure are merely for the convenience of description, and do not imply the preference among the embodiments.

When integrated units in the foregoing embodiments are implemented in a form of a software operation unit and sold or used as an independent product, the units may be stored in the foregoing computer-readable storage medium. Based on such an understanding, the technical solutions of the present disclosure essentially, or the part contributing to the prior art, or all or some of the technical solutions may be implemented in a form of a software product. The computer software product is stored in a storage medium and includes several instructions for instructing one or more computer devices (which may be a personal computer, a server, a network device, or the like) to perform all or some of the steps of the methods described in the embodiments of the present disclosure.

In the foregoing embodiments of the present disclosure, descriptions of the embodiments have different emphases, and for parts that are not described in detail in one embodiment, reference may be made to relevant descriptions of the other embodiments.

In the several embodiments provided in this application, it should be understood that the disclosed client may be implemented in other manners. The described apparatus embodiments are merely exemplary. For example, the unit division is merely logical operation division and may be other division in actual implementation. For example, a plurality of units or components may be combined or integrated into another system, or some features may be ignored or not performed. In addition, the displayed or discussed mutual couplings or direct couplings or communications connections may be implemented through some interfaces. The indirect couplings or communications connections between the units or modules may be implemented in electronic or other forms.

The units described as separate parts may or may not be physically separate, and the parts displayed as units may or may not be physical units, may be located at one position, or may be distributed on a plurality of network units. Some or all of the units may be selected according to actual needs to achieve the objectives of the solutions of the embodiments.

In addition, operation units in the embodiments of the present disclosure may be integrated into one processing unit, or each of the units may exist alone physically, or two or more units may be integrated into one unit. The integrated unit may be implemented in the form of hardware, or may be implemented in the form of a software operation unit.

The foregoing descriptions are merely preferred implementations of present disclosure. It should be pointed out that a person of ordinary skill in the art may further make several improvements and modifications without departing from the principle of the present disclosure. The improvements and modifications should also be considered to fall within the protection scope of the present disclosure.

What is claimed is:

1. A method for controlling a sticker classification identifier performed at a computing device having one or more processors and memory storing a plurality of programs to be executed by the one or more processors, the method comprising:
displaying an instant messaging user interface, the instant messaging user interface including a user input region and a plurality of messaging options, the plurality of messaging options including an audio messaging option, a video messaging option, and a sticker messaging option;
detecting a user selection of the sticker messaging option;
updating the instant messaging user interface by displaying a sticker panel below the user input region, the sticker panel including one or more sticker classification identifiers, each sticker classification identifier further including one or more stickers;
obtaining a movement instruction to be applied to a first sticker classification identifier of the one or more sticker classification identifiers, the movement instruction being used to move the first sticker classification identifier on the sticker panel from a current position to a target position;
obtaining a first operation indicated by a first area in which the target position is located; and
performing the first operation on the first sticker classification identifier by moving the first sticker classification identifier from the current position to the target position without moving the one or more stickers of the first sticker classification identifier.

2. The method according to claim 1, wherein the updating the instant messaging user interface by displaying a sticker panel below the user input region comprises:
highlighting the sticker messaging option such that the sticker messaging option is displayed in the instant messaging user interface in a manner that is visually distinguishable from the audio messaging option and the video messaging option.

3. The method according to claim 1, wherein the performing the first operation on the first sticker classification identifier comprises:
determining whether the first area comprises a second area in which any two adjacent sticker classification identifiers in a sticker classification identifier list are located;
if it is determined that the first area comprises the second area in the sticker classification identifier list, displaying an idle area between the two adjacent sticker classification identifiers when the first sticker classification identifier partially or completely overlaps with the second area; and
moving the first sticker classification identifier to the idle area.

4. The method according to claim 3, wherein the displaying an idle area between the two adjacent sticker classification identifiers comprises:
controlling a sticker classification identifier on a first side of the first sticker classification identifier located at the target position to move to a first direction, wherein the first direction is a direction from the first sticker classification identifier to the sticker classification identifier on the first side; and/or
controlling a sticker classification identifier on a second side of the first sticker classification identifier located at the target position to move to a second direction, wherein the second direction is a direction from the first sticker classification identifier to the sticker classification identifier on the second side, and the first direction is opposite to the second direction.

5. The method according to claim 3, wherein when the first operation is to move the first sticker classification identifier to the idle area, deleting the first sticker classification identifier when the first sticker classification identifier is moved to an area outside the first area.

6. The method according to claim 1, the method further comprises:
after obtaining the movement instruction:
controlling the first sticker classification identifier to move from an initial area in the sticker classification identifier list to the first area; and
controlling other sticker classification identifiers, other than the first sticker classification identifier, in the sticker classification identifier list to move in sequence according to a direction pointing to the initial area.

7. The method according to claim 6, the method further comprises:
after controlling other sticker classification identifiers, other than the first sticker classification identifier, in the sticker classification identifier list to move in sequence according to a direction pointing to the initial area:
determining whether the quantity of the other sticker classification identifiers is less than the quantity of areas, for displaying sticker classification identifiers, in the sticker classification identifier list;
if the quantity of the other sticker classification identifiers is less than the quantity of the areas, for displaying the sticker classification identifiers, in the sticker classification identifier list, displaying an area, which does not display a sticker classification identifier, in the sticker classification identifier list as an idle area; and
if the quantity of the other sticker classification identifiers is greater than or equal to the quantity of the areas, for displaying the sticker classification identifiers, in the sticker classification identifier list, displaying a second sticker classification identifier in the sticker classification identifier list, wherein the second sticker classification identifier is not displayed in the sticker classification identifier list before the first sticker classification identifier is moved.

8. The method according to claim 1, the method further comprises:
after obtaining the movement instruction:
enlarging the first sticker classification identifier, to obtain an enlarged first sticker classification identifier; and
displaying the enlarged first sticker classification identifier.

9. The method according to claim 1, wherein the performing the first operation on the first sticker classification identifier comprises:
deleting the first sticker classification identifier from the first area, wherein when the first sticker classification identifier is deleted, the plurality of stickers comprised in the first sticker classification identifier are deleted from the sticker classification identifier list.

10. The method according to claim 9, wherein a deletion icon is displayed in the first area, and the deleting the first sticker classification identifier from the first area comprises:
when the first sticker classification identifier is moved to the deletion icon, controlling a display color of the deletion icon to be gradually darkened, and when the first sticker classification identifier is located in a preset area in which the deletion icon is located, controlling the deletion icon to turn from a first icon into a second icon.

11. A computing device comprising one or more processors, memory coupled to the one or more processors, and a plurality of programs stored in the memory that, when executed by the one or more processors, cause the computing device to perform the following operations:
displaying an instant messaging user interface, the instant messaging user interface including a user input region and a plurality of messaging options, the plurality of messaging options including an audio messaging option, a video messaging option, and a sticker messaging option;
detecting a user selection of the sticker messaging option;
updating the instant messaging user interface by displaying a sticker panel below the user input region, the sticker panel including one or more sticker classification identifiers, each sticker classification identifier further including one or more stickers;
obtaining a movement instruction applied to a first sticker classification identifier of the one or more sticker classification identifiers, the movement instruction being used to move the first sticker classification identifier on the sticker panel from a current position to a target position;
obtaining a first operation indicated by a first area in which the target position is located; and
performing the first operation on the first sticker classification identifier by moving the first sticker classification identifier from the current position to the target position without moving the one or more stickers of the first sticker classification identifier.

12. The computing device according to claim 11, wherein the updating the instant messaging user interface by displaying a sticker panel below the user input region comprises:
highlighting the sticker messaging option such that the sticker messaging option is displayed in the instant messaging user interface in a manner that is visually distinguishable from the audio messaging option and the video messaging option.

13. The computing device according to claim 11, wherein the performing the first operation on the first sticker classification identifier comprises:
determining whether the first area comprises a second area in which any two adjacent sticker classification identifiers in a sticker classification identifier list are located;
if it is determined that the first area comprises the second area in the sticker classification identifier list, displaying an idle area between the two adjacent sticker classification identifiers when the first sticker classification identifier partially or completely overlaps with the second area; and
moving the first sticker classification identifier to the idle area.

14. The computing device according to claim 13, wherein the displaying an idle area between the two adjacent sticker classification identifiers comprises:
controlling a sticker classification identifier on a first side of the first sticker classification identifier located at the target position to move to a first direction, wherein the first direction is a direction from the first sticker classification identifier to the sticker classification identifier on the first side; and/or
controlling a sticker classification identifier on a second side of the first sticker classification identifier located at the target position to move to a second direction, wherein the second direction is a direction from the first sticker classification identifier to the sticker classification identifier on the second side, and the first direction is opposite to the second direction.

15. The computing device according to claim 13, wherein when the first operation is to move the first sticker classification identifier to the idle area, deleting the first sticker classification identifier when the first sticker classification identifier is moved to an area outside the first area.

16. The computing device according to claim 11, wherein the operations further comprise:
after obtaining the movement instruction:
controlling the first sticker classification identifier to move from an initial area in the sticker classification identifier list to the first area; and
controlling other sticker classification identifiers, other than the first sticker classification identifier, in the sticker classification identifier list to move in sequence according to a direction pointing to the initial area.

17. The computing device according to claim 11, wherein the operations further comprise:
after obtaining the movement instruction:
enlarging the first sticker classification identifier, to obtain an enlarged first sticker classification identifier; and
displaying the enlarged first sticker classification identifier.

18. The computing device according to claim 11, wherein the performing the first operation on the first sticker classification identifier comprises:
deleting the first sticker classification identifier from the first area, wherein when the first sticker classification identifier is deleted, the plurality of stickers comprised in the first sticker classification identifier are deleted from the sticker classification identifier list.

19. A non-transitory computer readable storage medium storing a plurality of programs that, when executed by one or more processors of a computing device, cause the computing device to perform the following operations:
displaying an instant messaging user interface, the instant messaging user interface including a user input region and a plurality of messaging options, the plurality of messaging options including an audio messaging option, a video messaging option, and a sticker messaging option;
detecting a user selection of the sticker messaging option;
updating the instant messaging user interface by displaying a sticker panel below the user input region, the sticker panel including one or more sticker classification identifiers, each sticker classification identifier further including one or more stickers;
obtaining a movement instruction applied to a first sticker classification identifier of the one or more sticker classification identifiers, the movement instruction being used to move the first sticker classification identifier on the sticker panel from a current position to a target position;
obtaining a first operation indicated by a first area in which the target position is located; and
performing the first operation on the first sticker classification identifier by moving the first sticker classification identifier from the current position to the target position without moving the one or more stickers of the first sticker classification identifier.

20. The non-transitory computer readable storage medium according to claim 19, wherein the updating the instant messaging user interface by displaying a sticker panel below the user input region comprises:
highlighting the sticker messaging option such that the sticker messaging option is displayed in the instant messaging user interface in a manner that is visually distinguishable from the audio messaging option and the video messaging option.
